(19) United States
(12) Patent Application Publication
(10) Pub. No.: US 2004/0054729 A1
(43) Pub. Date: Mar. 18, 2004

(54) Communication system, communication server and communication method

(75) Inventors: Takeshi Fukuizumi, Tokyo (JP); Shintaro Suzuki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/655,351

(22) Filed: Sep. 5, 2003

(30) Foreign Application Priority Data
Sep. 6, 2002 (JP) 262076/2002

(51) Int. Cl. G06F 15/16

(52) U.S. Cl. 709/205; 709/206

(57) ABSTRACT

A communication system comprising a plurality of user terminals connected to a communication network and a communication server connected to the communication network, wherein that communication server, when a chat start event has occurred, starts a chat simultaneously among user terminals related in advance to the chat start event out of the plurality of user terminals.

### BACKGROUND OF THE INVENTION

1. Field of the Invention

The present invention relates to a communication system, a communication server and a communication method utilizing a communication network (the Internet or a wireless network), and more particularly to a communication system, a communication server, and a communication method for creating a chat room or a chat community in which a plurality of persons can participate and exchange messages.

2. Description of the Related Art

In recent years, the expansion of instant messaging services such as American Online and Microsoft Messenger has made possible real time exchanging of messages using a network. Services enabling users, even if their terminals are far apart from each other, to enjoy chatting by data communication by way of a communication network are becoming more and more extensively available. Such services find their way not only in stationary communication networks via the Internet but also in mobile communication networks.

Where such an instant messaging service is used, once users registers themselves each as a “buddy” by using their respective user terminals, each user, when accessing a server via his or her user terminal, can reference presence information on other users. Presence information indicates whether or not a given user is accessible via user terminals, whether the user is “online” (the user is accessible) or “offline” (the user is not accessible), “available” (can chat) or “not available” (cannot chat) and so forth. In this system, information indicating who is a buddy with whom is dubbed a “buddy list”.

Communication by a message takes place not always in a one-to-one situation, but may take a form in which one user distributes a message to a plurality of persons at the same time. For instance, a mail magazine is a form of e-mail copies of which are distributed by a commercial publisher or an individual in expectation of extensive reception and readership. In recent years, such mail magazines are increasing both in variety and in readership size.

There are systems which allow users accessing the same network resource to chat with one another. In such a system, when a network resource (URL) accessed by user terminals is notified to a server, the server assumes that users accessing the same URL at the time constitute one chat group, and enables the users of the group to exchange messages among them.

However, the prior art described above involves the following problems. First, since it is up to each user whether or not to access a given network resource, the timing of joining or leaving a chat group differs from user to user. Therefore, because some users join or leave a chat on the way, the differences in timing among the users may cause the conversation to diverge (fail to converge).

Second, not all the users accessing the same network resource are always interested in the same topic. Whether or not to access a URL is up to the user's mood at the time, and the purpose of accessing a URL may widely vary among users. This results in another problem that, even if users accessing the same URL are put together into a chat group, they cannot agree on the theme (contents) of their conversation, which therefore would diverge.

Third, since the number of users to participate in a chat group is unpredictable, there is still another problem that the chat group cannot be organized in the right size to ensure a lively conversation.

### SUMMARY OF THE INVENTION

An object of the present invention, therefore is to provide a communication system, a communication server and a communication method for enabling a plurality of users to chat at the same time.

Another object of the invention is to provide a communication system, a communication server and a communication method for enabling users related to a chat start event to be organized into a chat group.

Still another object of the invention is to provide a communication system, a communication server and a communication method for identifying the users participating in the chat.

A communication system according to the invention comprises a plurality of user terminals connected to a communication network, and a communication server connected to the communication network, wherein the communication server, when a chat start event has occurred, causes a chat to be started at a prescribed timing among those user terminals, out of the plurality of user terminals, related in advance to the chat start event.

A communication server, according to the invention, connected to a plurality of user terminals via a communication network, comprises a presence information database in which are registered an identifier by which each of the plurality of user terminals identifies itself and related information, a group organizing unit which, when a chat start event has occurred, references the presence information database and selects, out of the identifiers of the plurality of user terminals, identifier of which the related information relates to the chat start event, and a buddy list generating/updating unit which transmits chart start information to user terminals matched to identifiers relating to the start event out of the plurality of user terminals, wherein the chart start information is an item of information to cause a chat to start at a prescribed timing among the plurality of user terminals.

A communication method, according to the invention, using a communication server connected to a plurality of user terminals via a communication network, comprises starting a chat at a prescribed timing, when a chat start event has occurred, among a plurality of user terminals, out of the user terminals, related in advance to the chat start event, and ending the chat at a prescribed timing, when a chat end event has occurred, among the plurality of user terminals.

A computer program, according to the invention, for causing communication among user terminals to be executed by using a communication server connected to a plurality of user terminals via a communication network, comprising steps to start a chat at a prescribed timing, when a chat start event has occurred, among a plurality of user terminals, out of the user terminals, related in advance to the chat start event, and to end the chat at a prescribed timing, when a chat end event has occurred, among the plurality of user terminals.

Thus according to the invention, it is possible to organize users sharing the same interest into a chat group by causing a communication server to select users of a plurality of user terminals relating to a chat start event so as to enable a chart to be started among the user terminals related in advance to the chat start event.

Also according to the invention, it is possible to let users relating to a chat start event, when the chat start event has occurred, simultaneously start a chat a prescribed timing among a plurality of user terminals by causing a communication server to transmit chat start information to a plurality of user terminals.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram illustrating the configuration of a communication system according to the invention;

FIG. 2 is a block diagram illustrating the configuration of a the communication server 1 of the communication system according to the invention;

FIG. 3 is a block diagram illustrating the configuration of a typical one of user terminals 2-1 through 2-m in the communication system according to the invention;

FIG. 4 is a functional block diagram illustrating a communication system, which is a first preferred embodiment of the invention;

FIG. 5 shows items of information registered in a presence information database 16 in the communication system, which is the first preferred embodiment of the invention;

FIG. 6 shows items of buddy list information in the communication system, which is the first preferred embodiment of the invention;

FIG. 7 shows a state in which users A, B, C and D are not related to each other in the communication system, which is the first preferred embodiment of the invention;

FIG. 8 shows a state in which users A, B, C and Dare related to each other in the communication system, which is the first preferred embodiment of the invention;

FIG. 9 shows a screen which is displayed on a user terminal 2-1 in a state in which users A, B, C and D are not related to each other in the communication system, which is the first preferred embodiment of the invention;

FIG. 10 shows a screen which is displayed on a user terminal 2-1 in a state in which users A, B, C and D are related to each other in the communication system, which is the first preferred embodiment of the invention;

FIG. 11 is a flow chart showing the operation of the communication system, which is the first preferred embodiment of the invention;

FIG. 12 is a functional block diagram illustrating a communication system, which is a second preferred embodiment of the invention;

FIG. 13 shows items of information registered in a presence information database 16 in the communication system, which is the second preferred embodiment of the invention;

FIG. 14 shows items of buddy list information in the communication system, which is the second preferred embodiment of the invention;

FIG. 15 shows items of buddy list information in the communication system, which is the second preferred embodiment of the invention;

FIG. 16 shows a state in which user X and users A, B and C are related to each other in the communication system, which is the second preferred embodiment of the invention;

FIG. 17 shows a state in which users A, B, C and X are related to one another in the communication system, which is the second preferred embodiment of the invention;

FIG. 18 is a flow chart showing the operation of the communication system, which is the second preferred embodiment of the invention;

FIG. 19 is a functional block diagram illustrating a communication system, which is a third preferred embodiment of the invention;

FIG. 20 shows items of information registered in a presence information database 16 in the communication system, which is the third preferred embodiment of the invention;

FIG. 21 shows items of buddy list information in the communication system, which is the third preferred embodiment of the invention;

FIG. 22 shows items of buddy list information in the communication system, which is the third preferred embodiment of the invention;

FIG. 23 is a flow chart showing the operation of the communication system, which is the third preferred embodiment of the invention; and

FIG. 24 is a functional block diagram illustrating a communication system, which is a fourth preferred embodiment of the invention.

### DETAILED DESCRIPTION OF PREFERRED EMBODIMENTS OF THE INVENTION

Before going into a detailed description of the present invention, the prior art will be described with a view to clarifying the technical context of the invention.

Examples of the prior art for providing a service enabling participants to enjoy chatting by data communication via a communication network include the Japanese Patent Applications Laid-open No. Hei 11-272610, No. 2002-82893, No. 2001-249872, No. 2001-222498 and No. 2001-520426.

For instance the Japanese Patent Application Laid-open No. Hei 11-272610 discloses a technique by which users acing the same network resource are enabled to chat with one another. In this conventional system, when the network resource (URL) accessed by a user terminal is notified to a server, the server assumes that users accessing the same URL at the time constitute one chat group, and enables the users of the group to exchange messages among them.

However, the prior art described above involves the following problems. First, since it is up to each user whether or not to access a given network resource, the timing of joining or leaving a chat group differs from user to user. Therefore, because some users join or leave a chat on the way, the differences in timing among the users may cause the conversation to diverge (fail to converge).

Second, not all the users accessing the same network resource are always interested in the same topic. Whether or not to access a URL is up to the user's mood at the time, and the purpose of accessing a URL may widely vary among users. This results in another problem that, even if users accessing the same URL are put together into a chat group, they cannot agree on the theme (contents) of their conversation, which therefore would diverge.

Third, since the number of users to participate in a chat group is unpredictable, there is still another problem that the chat group cannot be organized in the right size to ensure a lively conversation.

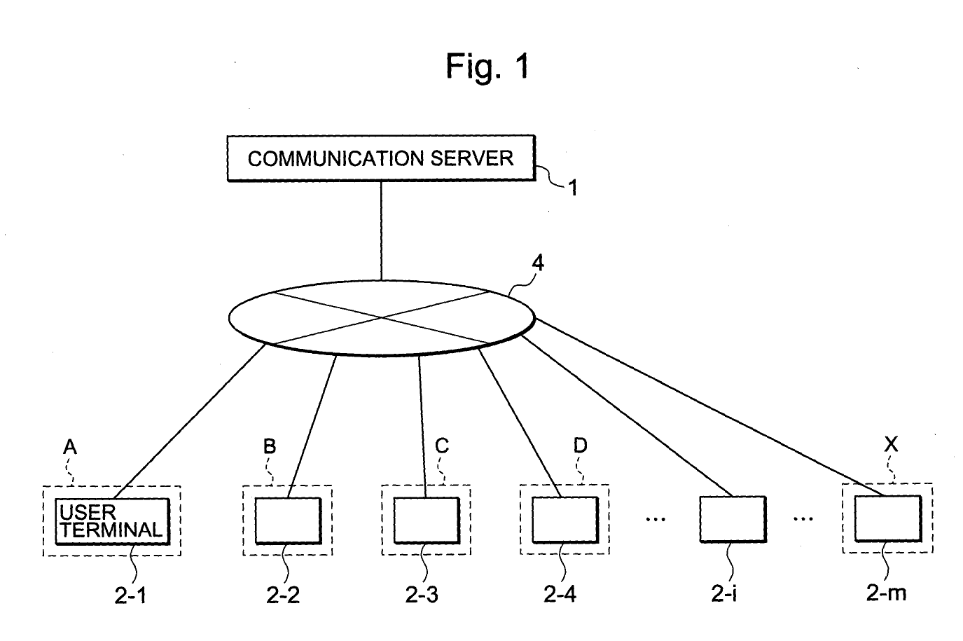

Communication systems embodying the present invention will be described below with reference to the accompanying drawings. FIG. 1 is a block diagram illustrating the configuration of a communication system. The communication system according to the invention is provided with a communication server 1 and a plurality of user terminals 2-1 through 2-m. The communication server 1 and the plurality of user terminals 2-1 through 2-m are connected to a communication network 4. The communication network 4 may be either a stationary communication network or a mobile communication network. The user terminals 2-1, 2-2, 2-3, 2-4 . . . , 2-m are to be used by users A, B, C, D, . . . , X, respectively.

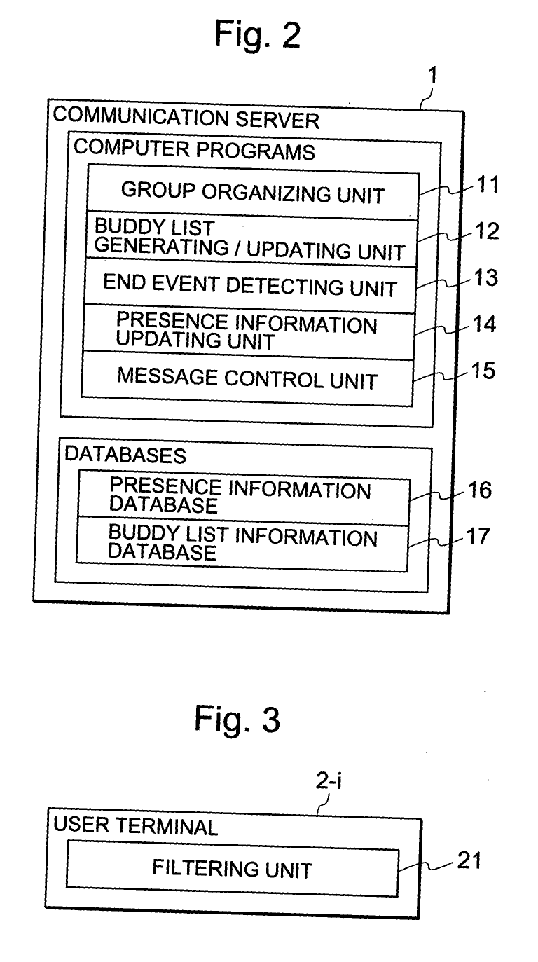

FIG. 2 is a block diagram illustrating the configuration of the communication server 1. The communication server 1 is provided with a group organizing unit 11, a buddy list generating/updating unit 12, an end event detecting unit 13, a presence information updating unit 14, a message control unit 15, a presence information database 16 and a buddy list information database 17. The group organizing unit 11, the buddy list generating/updating unit 12, the end event detecting unit 13, the presence information updating unit 14 and the message control unit 15 function as computer programs.

FIG. 3 shows the configuration of a typical one of the user terminals 2-1 through 2-m. The user terminals 2-1 through 2-m are mobile telephones, for instance. Each of these user terminals 2-1 through 2-m has the functions of a Global Positioning System (GPS) (not shown) in addition to the usual functions of a mobile telephone (e.g. the receiver, transmitter and controller functions) (not shown). The controller (CPU) of each of the user terminals 2-1 through 2-m further has the function of a filtering unit 21, which is a computer program.

(First Embodiment)

First will be described a case in which, triggered by a mail magazine distributed from outside, a chat group of mail magazine subscribers.

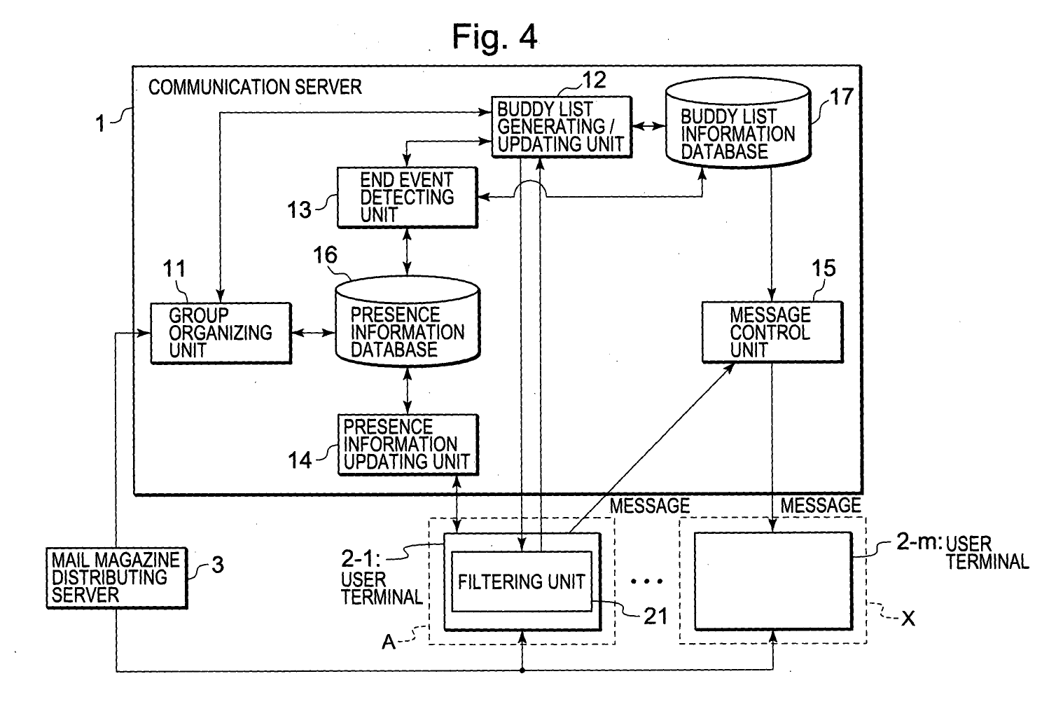

FIG. 4 is a block diagram illustrating a communication system, which is a first preferred embodiment of the invention. The communication system embodying the invention in this mode is configured of the communication server 1, a mail magazine server 3 and the plurality of user terminals 2-1 through 2-m. Although the illustration of a communication network unit is simplified with in FIG. 4 with a view to making clearer the connections and operations of different functions, actually the servers and user terminals are connected via the communication network.

In the communication system of the first embodiment, the mail magazine distributing server 3 is connected to the communication server 1 and the user terminals 2-1 through 2-m via the communication network. The mail magazine distributing server 3 periodically (e.g. daily or weekly) edits a mail magazine, which is a form of e-mail, and distributes the mail magazine to the user terminals 2-1 through 2-m. Also, the mail magazine distributing server 3 sends to the communication server 1 the same mail magazine as what is distributed to the user terminals 2-1 through 2-m. The mail magazine may be sent either by the usual e-mail transmitting method using the Internet or by using the short message service (SMS) of a mobile communication network. In the description of this embodiment, x will be the ID for identifying the mail magazine, and the mail magazine sent from the mail magazine distributing server 3 will be referred to as the “mail magazine x”.

Each of the user terminals 2-1 through 2-m has an identifier to identify itself. The identifiers of the user terminals 2-1, 2-2, 2-3, 2-4, 2-5, . . . , 2-m will be referred to as “A”, “B”, “C”, “D”, “E”, . . . , X as items of information (including names, addresses, telephone numbers and e-mail addresses) of the users A, B, C, D, E, . . . , X.

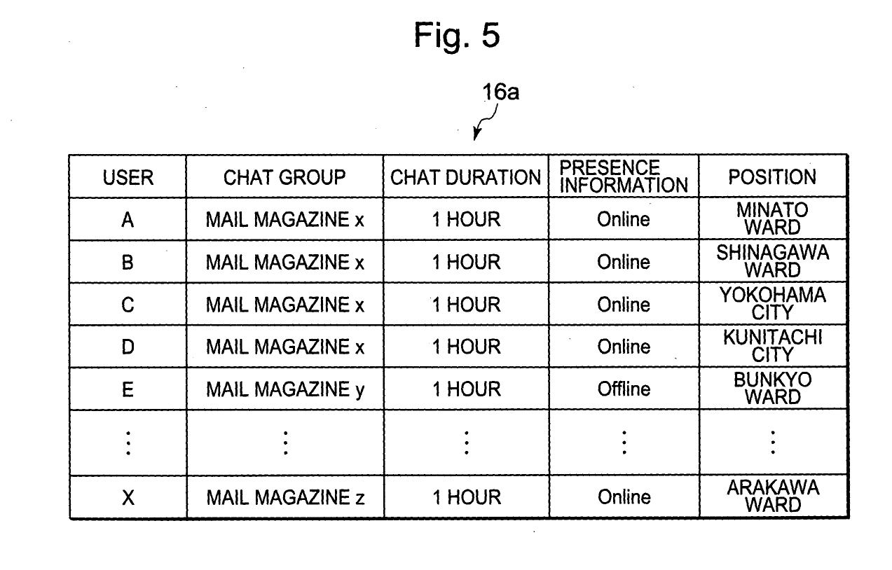

FIG. 5 shows items of information (16a) registered in a presence information database 16 in the communication system, which is the first preferred embodiment of the invention. As shown in FIG. 5, in the presence information database 16, there are registered in advance by the presence information updating unit 14 the identifiers of the users (“A”, “B”, . . . , “X” in FIG. 5), items of chat group-related information (“mail magazine X”, “mail magazine X”, . . . “mail magazine Z” in FIG. 5), set durations of chatting (“1 hour”, “1 hour”, . . . in FIG. 5), presence information as the state of communication (“Online”, “Online”, . . . in FIG. 5) and items of positional information on the users (“Minato Ward”, “Shinagawa Ward”, . . . in FIG. 5) each properly matched with others.

The presence information indicates whether or not the user of each of the user terminals 2-1 through 2-m is accessible The presence information “Online” means that the pertinent user is accessible. The presence information “Offline” means that the pertinent user is inaccessible. Presence information on each user terminal can be known by, for instance, having the presence information updating unit 14 of the communication server 1 inquire of the user terminals 2-1 through 2-m as to the presence information on each at regular intervals of time. In this case, the user terminals 2-1 through 2-m respond to this inquiry by returning the current presence information together with their respective identifiers “A” through “X”. If there is no response from the user terminal 2-5, for instance, the presence information updating unit 14 will assume that either the power supply to the user terminal 2-5 is off or the user E using the user terminal 2-5 is busy, and update the presence information registered in the presence information database 16 to match the identifier “E” as being “Offline”. The above-described method for knowing the presence information is but one example, and there also are other available methods.

The positional information indicates the respective positions of the user terminals 2-1 through 2-m, is always determined by using the GPSs of the user terminals 2-1 through 2-m. The user terminals 2-1 through 2-m always transmit their respective positional information and identifiers “A” through “X” to the communication server 1. The presence information updating unit 14 of the communication server 1 receives the positional information and the identifiers “A” through “X” from the user terminals 2-1 through 2-m, and updates the positional information, matched to the identifiers “A” through “X”, in the presence information database 16 at regular intervals of time.

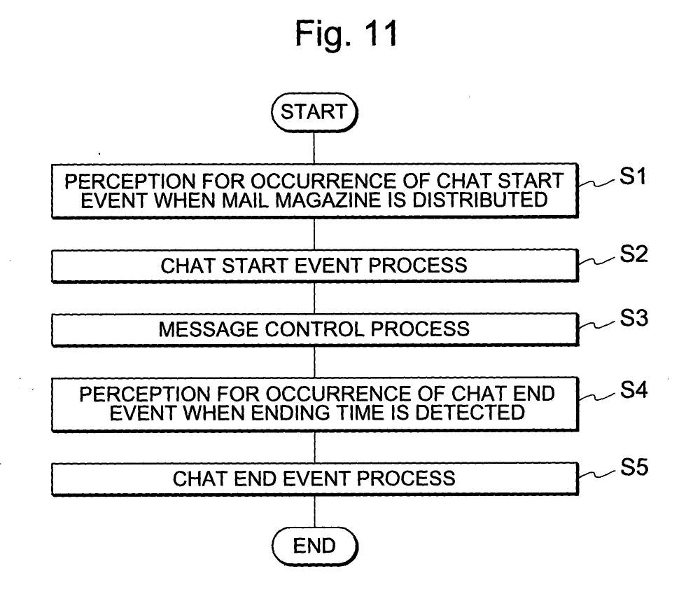

Next will be described in detail the operation of the communication system, which is the first preferred embodiment of the invention, and its functions with reference to FIG. 5 and FIG. 11. FIG. 11 is a flow chart showing the operation of the communication system embodying the invention in the first mode.

The group organizing unit 11 of the communication server 1, upon receiving the mail magazine x from the mail magazine distributing server 3, perceives the occurrence of a chat start event (Step S1 in FIG. 11). Then, upon perceiving the chat start event, the communication server 1 processes the chat start event (Step S2 in FIG. 11).

In processing the chat start event (Step S2), the group organizing unit 11 references the presence information database 16 and selects, out of the identifiers “A” through “X” registered in advance, the identifiers of which the presence information is “Online”, indicating accessibility, and the related information (chat group) is related to the chat start event (mail magazine x) (regarding this information, the identifiers are supposed to be “A”, “B”, “C” and “D” by way of example). Thus the pertinent users are selected. In this way the group organizing unit 11, when the identifiers “A”, “B”, “C” and “D” of the users A, B, C and D (users subscribing to the same mail magazine x as users interested in the same field) have been selected, relates the users A, B, C and D as being buddies to one another, and notifies the buddy list generating/updating unit 12 of these buddies. Incidentally, the group organizing unit 11 may as well be caused to select the plurality of identifiers “A” through “Z” irrespective of whether the presence information indicates accessibility or inaccessibility.

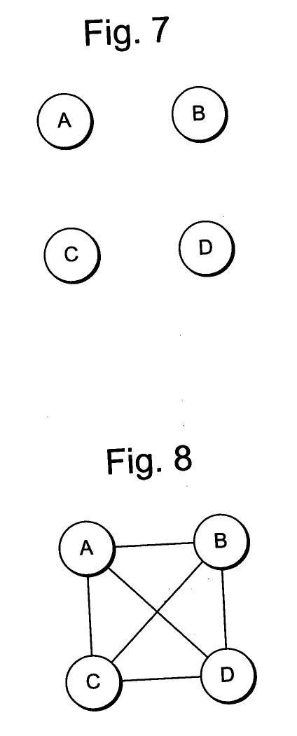

Next the buddy list generating/updating unit 12, to enable the users A, B, C and D (the user terminals 2-1, 2-2, 2-3 and 2-4) to exchange (transmit/receive) messages regarding the mail magazine x among one another, generates buddy list information on a state in which chatting is possible as shown in FIG. 8 away from a state in which the users are independent of one another as shown in FIG. 7.

Further in the chat start event processing (Step S2), the buddy list generating/updating unit 12 registers (updates) the generated buddy list information with the buddy list information database 17.

Thus in the communication system embodying the invention in the first mode, the users A, B, C and D related to the chat start event, which is a mail magazine in this case, can be organized into one chat group as users interested in the same field.

The format of transmitting and receiving messages in chatting may be a text form, or a multimedia form making full use of voice data, still picture data and moving picture data.

The buddy list information relates the respective users A, B, C and D of the user terminals 2-1, 2-2, 2-3 and 2-4 matching the identifiers “A”, “B”, “C” and “D” selected by the group organizing unit 11 to one another as buddies. Thus the buddy list information represents the users A, B, C and D who can chat on the mail magazine x among the, and includes the identifiers “C” and “D”.

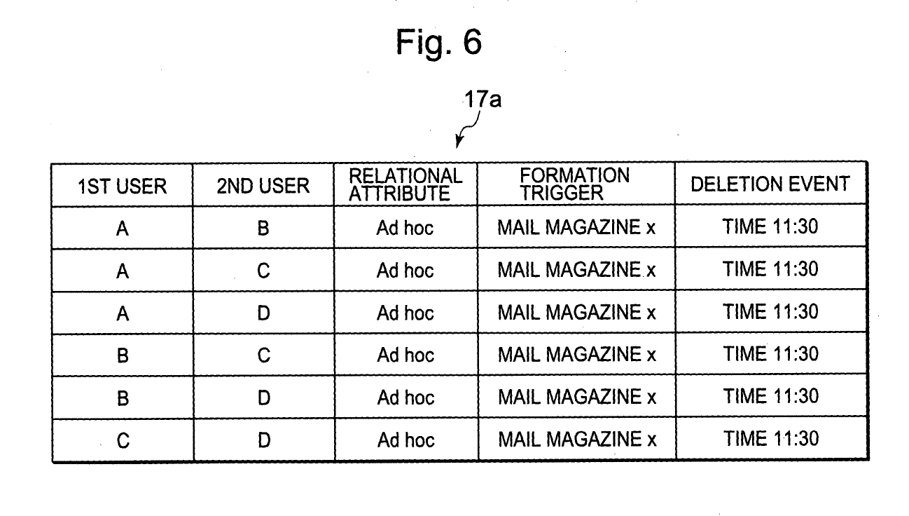

FIG. 6 shows items of buddy list information in the communication system, which is the first preferred embodiment of the invention. As shown in FIG. 6, the buddy list information relates to one another the identifiers “A”, “A”, “A”, “B”, “B” and “C” representing first users, the identifiers “B”, “C”, “D”, “C”, “D” and “D” representing second users, the same relational attribute “Ad hoc”, the “mail magazine x” which triggered the formation of one chat group and the same deletion event “Time 11:30”.

The deletion event is an item of information disbanding the chat group “mail magazine x” when the ending time has come. The ending time is, where the starting time of chatting is “10:30”, the point of time when the chatting duration of “one hour” registered in advance in the presence information database 16 has passed since that starting time of “10:30”, i.e. “11:30”.

Then in the chat start event processing (Step S2), the buddy list generating/updating unit 12, when it has updated the buddy list information, transmits chart start information and buddy list information to the plurality of user terminals 2-1, 2-2, 2-3 and 2-4 as buddy list update information. The chart start information is an item of information for starting chatting among the plurality of the user terminals 2-1, 2-2, 2-3 and 2-4 at a prescribed timing. Thus in the communication system, which is the first embodiment of the invention, when a chat start event has arisen, the users A, B, C and D related to the chat start event are enabled to start charting at the prescribed timing as the communication server 1 transmits chart start information to the plurality of the user terminals 2-1, 2-2, 2-3 and 2-4. The users A, B, C and D can participate in a chat room or a chat community at the same time.

When the user terminals 2-1, 2-2, 2-3 and 2-4 have received the buddy list update information including the chart start information and the buddy list information, the buddy list information is stored into memories (not shown) in the user terminals 2-1, 2-2, 2-3 and 2-4. In the communication system, which is the first embodiment of the invention, the users participating in the chat can be identified as the users A, B, C and D display the buddy list information on the user terminals 2-1, 2-2, 2-3 and 2-4.

Before the user terminals 2-1, 2-2, 2-3 and 2-4 receive the chart start information and the buddy list information, the users A, B, C and D are not related to one another as shown in FIG. 7, but once the user terminals 2-1, 2-2, 2-3 and 2-4 receive the chart start information and the buddy list information, the users A, B, C and D change into a state in which they are related to one another as shown in FIG. 8.

In the state shown in FIG. 8, the users A, B, C and D can either chat with other users by using the user terminals 2-1, 2-2, 2-3 and 2-4 on a one-to-one basis (for instance the user A can chat with the user B, C or D) or transmit the same message to the user terminals of all other users in the broadcast formula. At this time, the message control unit 15 carries out message control processing (Step S3 in FIG. 11).

In the message control processing (Step S3), the message control unit 15, when it has receives a message in the broadcast formula from the user terminal 2-1 for instance, references the buddy list information registered in the buddy list information database 17 and, if the users A, B, C and D are found in a state of being related to one another (see FIG. 8), transmits the message to the user terminals 2-2, 2-3 and 2-4 of the other users B, C and D. If, for instance, the users A, B, C and D are in a state of not being related to one another (see FIG. 7) at Step S3, the message control unit 15, even if receives a message in a broadcast formula from the user terminal 2-1, does not transmit that message to the user terminals 2-2, 2-3 and 2-4 of the other users B, C and D.

Here at Step S3 it is possible, for instance, for the user A to check whether or not the user terminals 2-2, 2-3 and 2-4 of the other users B, C and D have received that message. In this case, the user terminal 2-1 transmits to the communication server 1 that message and a message confirmation request to check the reception of the message. The message control unit 15 of the communication server 1, after transmitting the message to the user terminals 2-2, 2-3 and 2-4, inquires of the user terminals 2-2, 2-3 and 2-4 at a prescribed timing as to the reception of that message.

In response to this inquiry, the user terminals 2-2, 2-3 and 2-4 return message reception information which indicates reception of the message. By transmitting the message reception information from the user terminals 2-2, 2-3 and 2-4 to the user terminal 2-1, the message control unit 15 enables the user A to check whether or not the other users B, C and D have received that message.

The end event detecting unit 13, referencing the buddy list information registered in the buddy list information database 17, perceives the occurrence of a chat end event at the ending time “11:30” (Step S4 in FIG. 11). The communication server 1, upon the occurrence of the chat end event, performs chat end event processing (Step S5 in FIG. 11).

In the chat end event processing (Step S5), the end event detecting unit 13 deletes the buddy list information registered in the buddy list information database 17, and generates buddy list delete information for deleting the buddy list information transmitted to the user terminals 2-1, 2-2, 2-3 and 2-4. The buddy list generating/updating unit 12 at the ending time “11:30” transmits chat end information and the buddy list delete information to the user terminals 2-1, 2-2, 2-3 and 2-4 as the buddy list update information. The chat end information is an item of information for ending a chat among the user terminals 2-1, 2-2, 2-3 and 2-4 at a prescribed timing. When the user terminals 2-1, 2-2, 2-3 and 2-4 have received the buddy list update information including the chat end information and the buddy list delete information, the user terminals 2-1, 2-2, 2-3 and 2-4 delete the buddy list information stored in their respective memories in accordance with the buddy list delete information. Then the users A, B, C and D return to a state in which they are not related to one another (see FIG. 7).

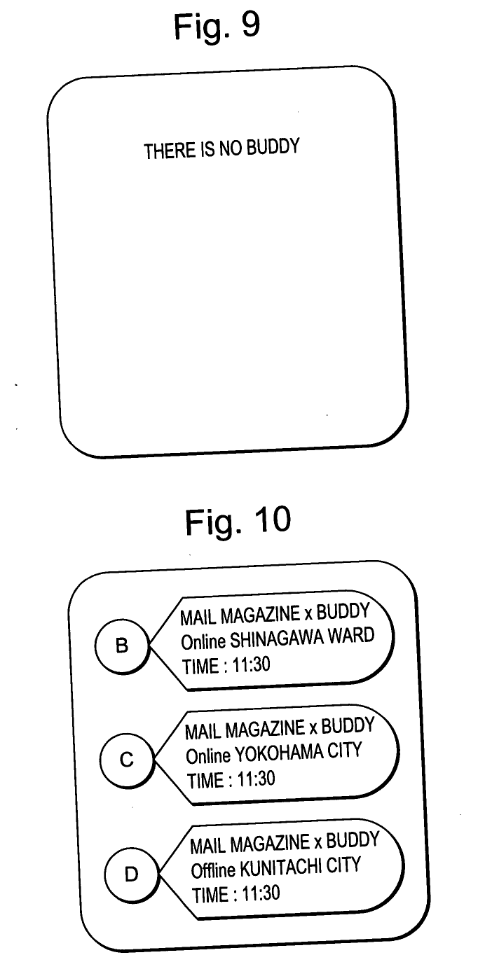

As described above, the buddy list generating/updating unit 12, upon updating (registering or deleting) the buddy list information, simultaneously distributes on a broadcast basis (transmits) the buddy list update information to the user terminals 2-1, 2-2, 2-3 and 2-4. This buddy list update information, when received by the user terminals 2-1, 2-2, 2-3 and 2-4, is displayed by the user terminals 2-1, 2-2, 2-3 and 2-4. For instance in a state in which the users A, B, C and D are not related to one another (see FIG. 7), the user terminal 2-1 of the user A displays the screen shown in FIG. 9, while in a state in which the users A, B, C and D are related to one another (see FIG. 8), the user terminal 2-1 displays the screen shown in FIG. 10 as the buddy list information. In this way, each of the users A, B, C and D can check on the screens of the user terminals 2-1, 2-2, 2-3 and 2-4 with whom he or she can chat.

Hereupon, when the user terminals 2-1, 2-2, 2-3 and 2-4 have received the buddy list update information (the buddy list information), the users A, B, C and D can select, by using the respective filtering units 21 of the user terminals 2-1, 2-2, 2-3 and 2-4, users available as chat partners out of the users covered by the buddy list information.

For instance, if the user A is not to take part in a chat, the filtering unit 21 of the user terminal 2-1 is operated by the user A to transmit non-participation information indicating the user A's unavailability for the chart to the communication server 1. The buddy list generating/updating unit 12 of the communication server 1, when it has received the non-participation information from the user terminal 2-1 in the message control processing (Step S3), references the buddy list information database 17, updates the buddy list information to reflect the non-participation of the user A in the chart, and transmits the updated buddy list information to the user terminals 2-2, 2-3 and 2-4. In this case, the buddy list information relates to one another the identifiers “B”, “B” and “C” representing first users, the identifiers “C”, “D” and “D” representing second users, the same relational attribute “Ad hoc”, the formation trigger “mail magazine x” for forming the same chat group and the same deletion event “Time 11:30”.

Or if the user A does not want to chat with the user B, the filtering unit 21 of the user terminal 2-1 is operated by the user A to transmit to the communication server 1 relationship delete information to the effect that the user A and the user B should not be related to each other. The buddy list generating/updating unit 12 of the communication server 1, when it has received the relationship delete information from the user terminal 2-1 in the message control processing (Step S3), references the buddy list information database 17, updates the buddy list information to reflect the absence of relationship between the user A and the user B, and transmits the updated buddy list information to the user terminals 2-1, 2-2, 2-3 and 2-4. In this case, the buddy list information relates to one another the identifiers “A”, “A”, “B”, “B” and “C” representing first users, the identifier “C”, “D”, “C”, “D” and “D” representing second users, the same relational attribute “Ad hoc”, the formation trigger “mail magazine x” for forming the same chat group and the same deletion event “Time 11:30”.

As described so far, the communication system, which is the first embodiment of the invention, when a chat start event has arisen, enables the users A, B, C and D . . . related to the chat start event to chat at a prescribed timing as the communication server 1 transmits chart start information to the plurality of the user terminals 2-1, 2-2, 2-3, 2-4 and so forth. In other words, the users A, B, C and D . . . are enabled to participate in a chat room or a chat community at the same time.

The communication system embodying the invention in the first mode, can organize the users A, B, C and D . . . sharing the same interest into a chat group, as the communication server 1 selects a plurality of identifiers related to the chat start event (the respective users A, B, C and D, . . . of the plurality of the user terminals 2-1, 2-2, 2-3 and 2-4, . . . ).

The communication system embodying the invention in the first mode can identify users to participate in a chat by having the users A, B, C and D, . . . display the buddy list information on the respective user terminals 2-1, 2-2, 2-3, 2-4 and so forth.

(Second Embodiment)

Next will be described a case of chat group formation among mail magazine subscribers triggered by a mail magazine distributed by a prescribed user.

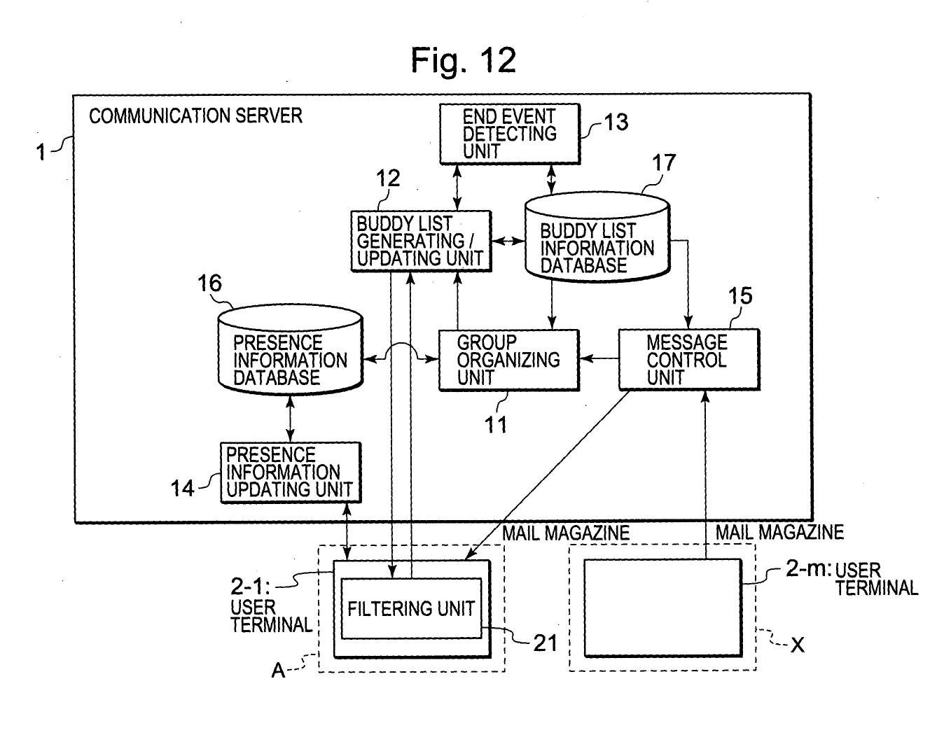

FIG. 12 is a functional block diagram illustrating a communication system, which is a second preferred embodiment of the invention. This communication system embodying the invention in the second mode differs from that in the first mode in that it has no mail magazine distributing server 3, but the user terminal of a prescribed user prepares a mail magazine, which is an e-mail, and distributes that mail magazine to the user terminals 2-1 through 2-m. The method of distributing the mail magazine is the same as in the first embodiment, and no duplication of description made of the first embodiment will be made. Here, the prescribed user is supposed to be the user X, and its user terminal, the user terminal 2-m. Also, the user X may as well be a predetermined one out of the users A through Y, or the manager of the communication server 1. Further, the user X is supposed to distribute the mail magazine x to the user terminals 2-1 through 2-(m−1), and also sends the mail magazine x to its own terminal (the user terminal 2-m) to make sure that the mail magazine x is duly distributed.

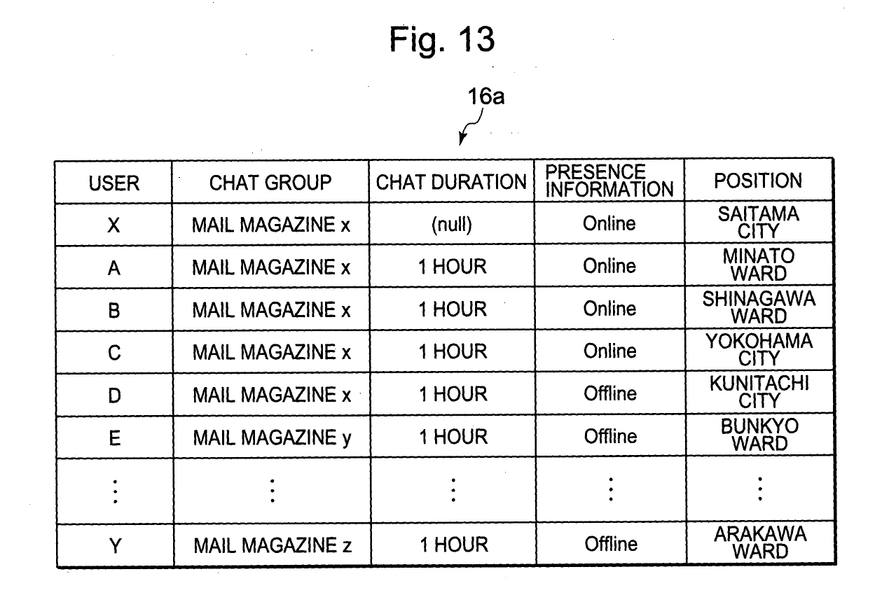

FIG. 13 shows items of information registered in the presence information database 16 in the communication system, which is the second preferred embodiment of the invention. As shown in FIG. 13, in the presence information database 16, related information on a chat group basis (“mail magazine x”, “mail magazine x” through “mail magazine z” in the drawing), set chat duration (“(null)”, “1 hour”, . . . in the drawing), presence information indicating the state of communication (“Online”, “Online”, . . . in the drawing) and positional information (“Saitama City”, “Minato Ward”, . . . in the drawing) are registered in advance, all related to the respective identifiers (users) (“X” and “A” through “Y” in the drawing), by the presence information updating unit 14. The entry “(null)” here means that no relevant information is registered. The perception of the presence information and the updating of the positional information take place in the same manner as in the first embodiment of the invention.

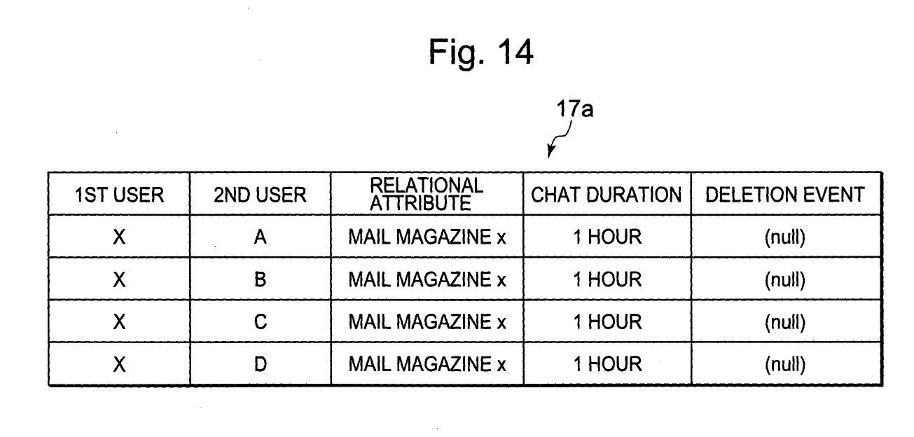

FIG. 14 shows items of buddy list information in the communication system, which is the second preferred embodiment of the invention. As shown in FIG. 14, in the buddy list information database 17, there is registered in advance a buddy list information 17a which relates to one another the identifier “X” representing the first user (specific user), the identifiers “A”, “B”, “C” and “D” representing second users, the same relational attribute “mail magazine x”, the same chat duration of “1 hour” and the same deletion event “(null)”.

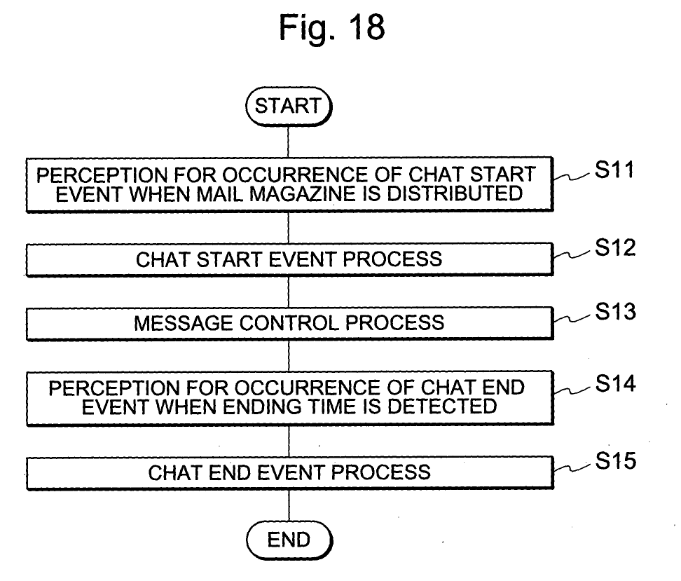

Next will be described in detail the operation of the communication system, which is the second preferred embodiment of the invention, and its functions with reference to FIG. 12 and FIG. 18. FIG. 18 is a flow chart showing the operation of the communication system embodying the invention in the second mode.

The message control unit 15 of the communication server 1 receives the mail magazine x from user terminal 2-m, and the group organizing unit 11 perceives the occurrence of a chat start event when the message control unit 15 has received the mail magazine x (Step S11 in FIG. 18). The communication server 1 performs chat start event processing when the chat start event has occurred (Step S12 in FIG. 18).

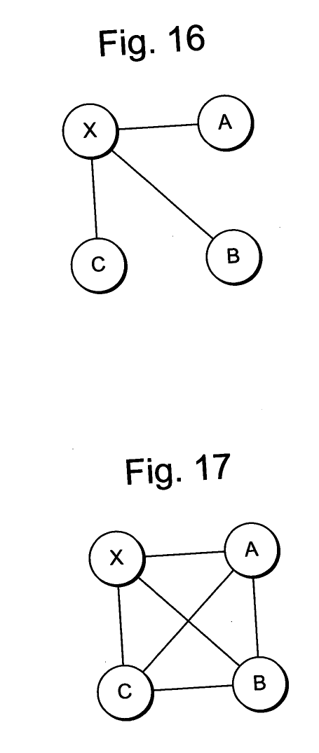

In the chat start event processing (Step S12), the group organizing unit 11 references the presence information database 16, and selects out of the identifier “X” and “A” through “Y” registered in advance, a plurality of identifiers “A”, “B”, “C” and “X” related to the presence information of “Online”, indicating accessibility, and the related information (chat group) of the chat start event (mail magazine x). Thus the communication server 1, when the identifiers “A”, “B” and “C” of the users A, B and C who are buddies to the user X (the users subscribing to same mail magazine x as users sharing the same interest), relates the users A, B, C and X as buddies to one another. This results in a change from the state shown in FIG. 16 to what is shown in FIG. 17, and the communication system embodying the invention in the second mode can organize the users A, B, C and X related to the chat start event as a chat group.

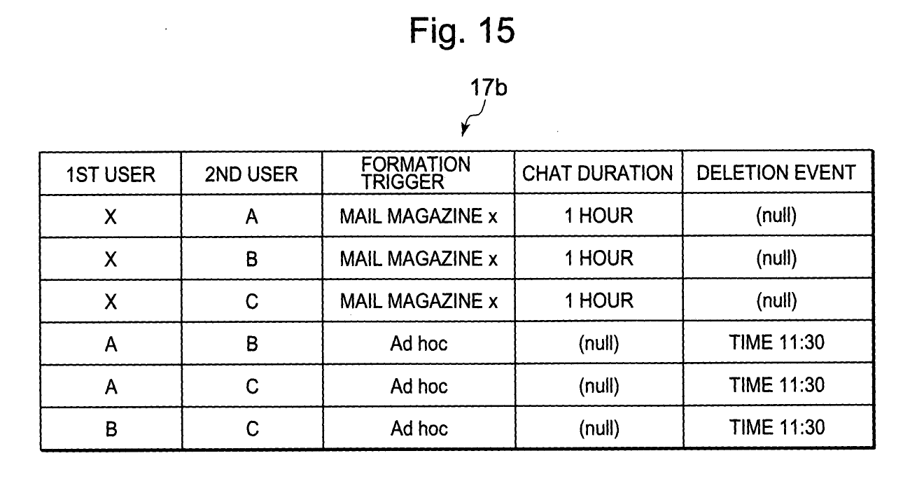

Next in the chat start event processing (Step S12), the buddy list generating/updating unit 12 references the buddy list information database 17, and generates a buddy list information 17b shown in FIG. 15 to enable the user A, B, C and X to exchange messages (e-mails) regarding the mail magazine x among one another. The buddy list information 17b relates to one another as buddies the respective users A, B, C and X of the user terminals 2-1, 2-2, 2-3 and 2-m matching the identifiers “A”, “B”, “C” and “X” selected by the group organizing unit 11. Thus the buddy list information 17b represents the user A, B, C and X who can chat about the mail magazine x, and includes the identifiers “A”, “B”, “C” and “X”. At Step S12, the buddy list generating/updating unit 12 registers in (updates) the buddy list information database 17 the newly generated buddy list information 17b to replace the buddy list information 17a shown in FIG. 14.

That buddy list information 17b, as shown in FIG. 15, relates to one another the identifiers “X”, “X”, “X”, “A”, “A” and “B” representing first users, the identifiers “A”, “B”, “C”, “B”, “C” and “C” representing second users, the same relational attributes “mail magazine x”, “mail magazine x”, “Ad hoc”, “Ad hoc” and “Ad hoc”, the same chat durations of “1 hour”, “1 hour”, “1 hour”, “(null)”, “(null)” and “(null)”, and the same deletion events of “(null)”, “(null)”, “(null)”, “Time 11:30”, “Time 11:30” and “Time 11:30”.

Then in the chat start event processing (Step S12), the buddy list generating/updating unit 12 transmits the chart start information and the buddy list information to the plurality of user terminals 2-1, 2-2, 2-3 and 2-m as the buddy list update information when the buddy list information has been updated. The chart start information is an item of information for starting a chat among the plurality of user terminals 2-1, 2-2, 2-3 and 2-m at a prescribed timing. In this way the communication system, which is the second embodiment of the invention, when a chat start event has occurred, the users A, B, C and X related to the chat start event can begin chatting at a prescribed timing as the communication server 1 transmits the chart start information to the plurality of user terminals 2-1, 2-2, 2-3 and 2-m. In other words, the users A, B, C and X can participate in a chat room or a chat community at a prescribed timing.

When the user terminals 2-1, 2-2, 2-3 and 2-4 have received the buddy list update information including the chart start information and the buddy list information, the buddy list information is stored into the respective memories (not shown) of the user terminals 2-1, 2-2, 2-3 and 2-4. The communication system embodying the invention in the second mode can identify users to participate in a chat by having the users A, B, C and X display the buddy list information on the respective user terminals 2-1, 2-2, 2-3 and 2-m.

Before the user terminals 2-1, 2-2, 2-3 and 2-m receive the chart start information and the buddy list information, the user X and the users A, B and C are in a state of being related to each other on a one-to-one basis as shown in FIG. 16, but the users A, B, C and X vary into a state of being mutually related as shown in FIG. 17 after the user terminals 2-1, 2-2, 2-3 and 2-m have received the chart start information and the buddy list information.

What takes place thereafter from Step S13 through S15 in FIG. 18 are similar to that from Step S3 through S5 in FIG. 11 described with reference to the first embodiment of the invention. With the user D and the user terminal 2-4 described with reference to the first embodiment being respectively replaced by the user X and the user terminal 2-m, the communication server 1 executes message control processing (Step S13), perception of the occurrence of the chat end event (Step S14) and chat end event processing (Step S15) in the same manner as in the first embodiment.

In this case, if the end event detecting unit 13 is to delete the buddy list information 17b registered in the buddy list information database 17 in the chat end event processing (Step S15), the buddy list information 17a shown in FIG. 14 is registered in the buddy list information database 17 as the end event detecting unit 13 delete only the record of “Ad hoc” out of the buddy list information 17b registered in the buddy list information database 17. At this time is resumed the state in which the user X and the users A, B and C are related to each other on a one-to-one basis as shown in FIG. 16. Further, when the user terminals 2-1, 2-2, 2-3 and 2-4 have received the buddy list update information including the chat end information and the buddy list delete information, the user terminals 2-1, 2-2, 2-3 and 2-4 deletes the buddy list information stored in the respective memories in accordance with the buddy list delete information.

As described so far, the communication system, which is the second embodiment of the invention, provides the same advantage as the first embodiment does.

(Third Embodiment)]

Next will be described a case of chat group formation among mail magazine subscribers triggered by presence information of a specific user.

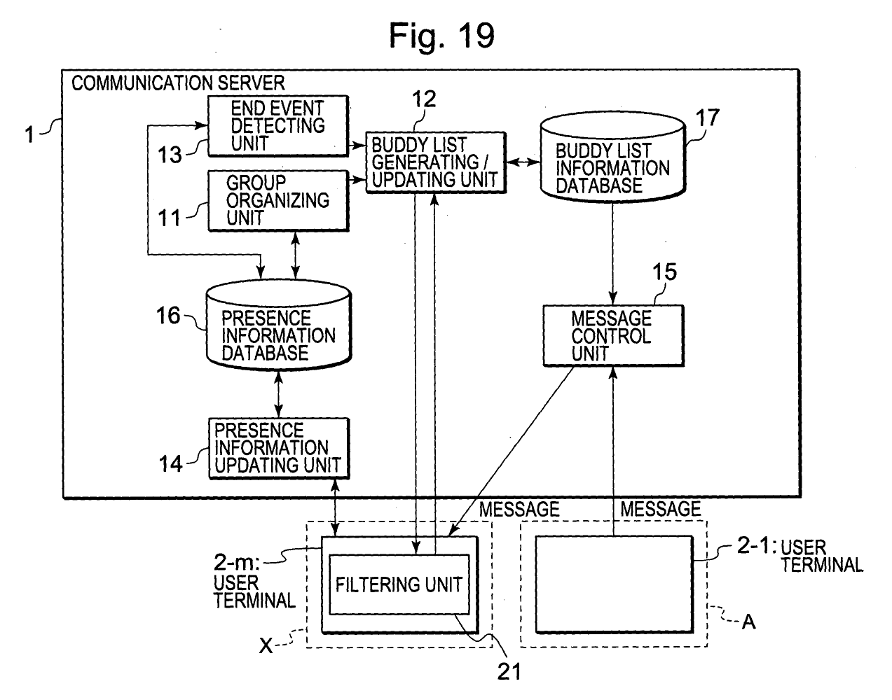

FIG. 19 is a functional block diagram illustrating a communication system, which is a third preferred embodiment of the invention. The communication system embodying the invention in the third mode differs from that in the second mode in that the group organizing unit 11 and the end event detecting unit 1 of the communication server 1 are constantly monitoring the presence information of a specific user (the user X) registered (updated) in the presence information database 16. No duplication of description made of the first embodiment of the second embodiment will be made.

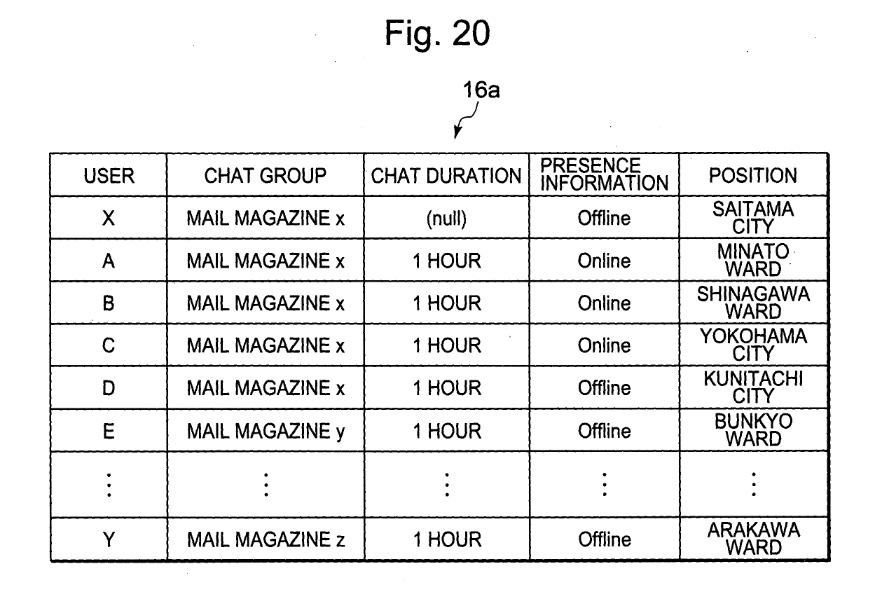

As shown in FIG. 20, in the presence information database 16, there are registered in advance by the presence information updating unit 14, each related to the respective identifiers (users) (“X” and “A” through “Y” in the drawing), related information on a chat group basis (“mail magazine x” and “mail magazine x” through “mail magazine z” in the drawing), set chat duration (“(null)”, “1 hour”, “1 hour”, . . . in the drawing), presence information indicating the state of communication (“Offline”, “Online”, . . . in the drawing) and positional information (Saitama City”, “Minato Ward”, “ . . . ”). Herein, “(null)” indicates the absence of pertinent information. The presence information is perceived and the positional information is updated in respectively the same manners as in the first embodiment.

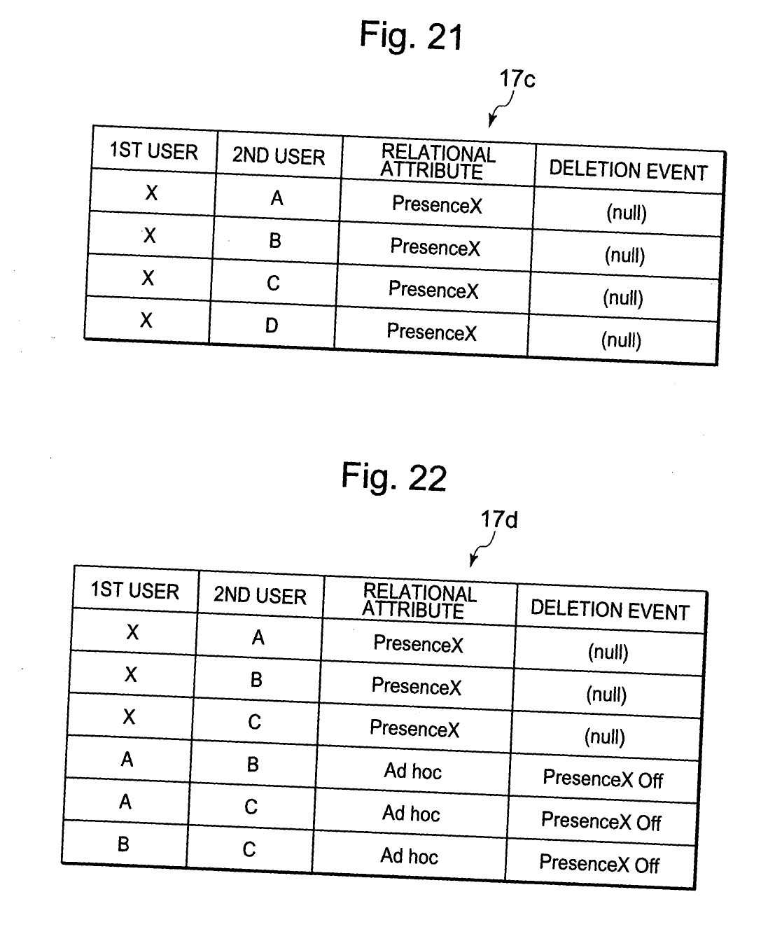

As shown in FIG. 21, in the buddy list information database 17 is registered in advance a buddy list information 17c which relates to one another the identifiers “X”, “X”, “X” and “X” representing a first user (a specific user), the identifiers “A”, “B”, “C” and “D” representing second users, the same relational attribute “Presence x”, and the same deletion event “(null)”, “(null),”, “(null)” and “(null)”. Herein, “(null)” indicates the absence of pertinent information.

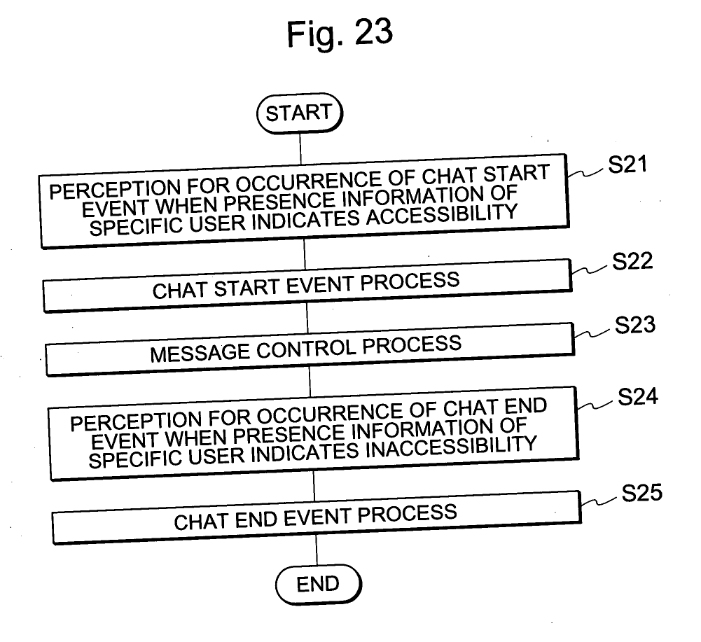

Next will be described in detail the operation of the communication system, which is the third preferred embodiment of the invention, and its functions with reference to FIG. 19 and FIG. 23. FIG. 23 is a flow chart showing the operation of the communication system, which is the third preferred embodiment of the invention.

The group organizing unit 11 of the communication server 1 references the presence information database 16 and, if presence information of the specific user (the user X) is “Online” indicating accessibility (see FIG. 13), perceives the occurrence of a chat start event (Step S21 in FIG. 23). The communication server 1, when the chat start event has arisen, carries out chat start event processing (Step S22 in FIG. 23).

In the chat start event processing (Step S22), the group organizing unit 11 references the presence information database 16, selects out of the identifiers “X” through “Y” registered in advance a plurality of identifiers “X”, “A”, “B” and “C” related to the presence information of “Online”, indicating accessibility, and the related information (chat group) of the chat start event (mail magazine x). In this way the communication server 1, when the identifiers “A”, “B” and “C” of the users A, B and C (users interested in conversing with a specific person (the user X) sharing the same interest) who are buddies to the user X have been selected, relates the users A, B, C and X to one another as buddies. This results in a change from the state shown in FIG. 16 to what is shown in FIG. 17, and the communication system embodying the invention in the third mode can organize the users A, B, C and X related to the chat start event as a chat group.

Next in the chat start event processing (Step S12), the buddy list generating/updating unit 12 references the buddy list information database 17, and generates a buddy list information 17d as shown in FIG. 22 to enable the users A, B, C and X to exchange messages (e-mails) with one another in response to the mail magazine x. The buddy list information 17d relates to one another as buddies the respective users A, B, C and X of the user terminals 2-1, 2-2, 2-3 and 2-m matching the identifiers “A”, “B”, “C” and “X” selected by the group organizing unit 11. Thus that buddy list information represents the users A, B, C and X who can chat about the mail magazine x, and includes the identifiers “A”, “B”, “C” and “X”. At Step S22, the buddy list generating/updating unit 12 registers in (updates) the buddy list information database 17 the newly generated buddy list information 17d shown in FIG. 22 to replace the buddy list information 17c shown in FIG. 21.

That buddy list information 17b, as shown in FIG. 22, relates to one another the identifiers “X”, “X”, “X”, “A”, “A” and “B” representing first users, the identifiers “A”, “B”, “C”, “B”, “C” and “C” representing second users, relational attributes “Presence X”, “Presence X”, “Presence X”, “Ad hoc”, “Ad hoc” and “Ad hoc”, and the same deletion events of “(null)”, “(null)”, “(null)”, “Presence X Off”, “Presence X Off” and “Presence X Off”.

Then in the chat start event processing (Step S22), the buddy list generating/updating unit 12, when the buddy list information has been updated, transmits the chart start information and the buddy list information to the plurality of user terminals 2-1, 2-2, 2-3 and 2-m as buddy list update information. The chart start information is an item of information for starting a chat among the plurality of user terminals 2-1, 2-2, 2-3 and 2-m at a prescribed timing. In this way, the communication system which is the third embodiment of the invention, when a chat start event has arisen, enables the users A, B, C and X related to the chat start event to start chatting at a prescribed timing as the communication server 1 transmits the chart start information to the plurality of user terminals 2-1, 2-2, 2-3 and 2-m. Thus, the users A, B, C and X can participate in a chat room or a chat community at the same time.

When the user terminals 2-1, 2-2, 2-3 and 2-4 have received the buddy list update information including the chart start information and the buddy list information, the buddy list information is stored into the respective memories (not shown) of the user terminals 2-1, 2-2, 2-3 and 2-4. In the communication system, which is the third embodiment of the invention, the users participating in the chat can be identified as the users A, B, C and X display the buddy list information on the user terminals 2-1, 2-2, 2-3 and 2-m.

Before the user terminals 2-1, 2-2, 2-3 and 2-m receive the chart start information and the buddy list information, the user X and the users A, B and C are in a state of being related to each other on a one-to-one basis as shown in FIG. 16, but the users A, B, C and X vary into a state of being mutually related as shown in FIG. 17 after the user terminals 2-1, 2-2, 2-3 and 2-m have received the chart start information and the buddy list information.

Step S23 in FIG. 23 here is similar to Step S12 in FIG. 19 described with reference to the second embodiment, and the communication server 1 executes the message control processing (Step S23) in the same way as in the second embodiment.

Next, the end event detecting unit 13 references the presence information database 16 and, when the presence information of a specific user (the user X) is “Offline” indicating inaccessibility (see FIG. 20), perceives the occurrence of a chat end event (Step S24 in FIG. 23). Step S25 in FIG. 23 is similar to Step S15 in FIG. 19 described with reference to the second embodiment, and the communication server 1 executes the chat end event processing (Step S25) in the same way as in the second embodiment.

As described so far, the communication system, which is the third embodiment of the invention, provides the same advantage as the first embodiment and second embodiment do.

In the first through third embodiments of the invention, in the chat start event processing (Steps S2, S12 and S22), the group organizing unit 11 of the communication server 1 can also perceive the occurrence of a chat start event when a predetermined first point of time has arrived.

In the first through third embodiments of the invention, in the chat end event processing (Step S5, S15, S25), the end event detecting unit 13 of the communication server 1 can also perceive the occurrence of a chat end event when a predetermined second point of time has arrived. Alternatively, the end event detecting unit 13 can as well perceive the occurrence of a chat end event if, after the lapse of a set length of time since messages were transmitted/received among a plurality of user terminals (e.g. the user terminals 2-1, 2-2, 2-3 and 2-4), no transmission/reception of messages takes place again among the user terminals 2-1, 2-2, 2-3 and 2-4.

In the first through third embodiments of the invention, the respective users (e.g. the users A, B, C and D) of a plurality of user terminals (e.g. the user terminals 2-1, 2-2, 2-3 and 2-4) relating to the chat start event are users who made telephone calls to the same telephone number by using the user terminals 2-1, 2-2, 2-3 and 2-4 (mobile telephones) in a predetermined time span (e.g. from 10:00 through 10:10). In this case, the user terminals 2-1, 2-2, 2-3 and 2-4 record in their respective memories the destination telephone number, which is the same for all the terminals, and the points of time of calls made to that destination telephone number, and the presence information updating unit 14 of the communication server 1, by inquiring of the user terminals 2-1, 2-2, 2-3 and 2-4, registers in the presence information database 16 the destination telephone number called by the user terminals 2-1, 2-2, 2-3 and 2-4 and the points of time of their calls as the chat group (related information), matched with the identifiers of the user terminals 2-1, 2-2, 2-3 and 2-4. Then, the group organizing unit 11 perceives the occurrence of a chat start event when, for instance, a first point of time (10:10) has come, references the presence information database 16, selects out of the identifiers “X” and “A” through “Y”, a plurality of identifiers “A”, “B”, “C” and “X” of which the presence information is “Online” indicating accessibility and the related information (chat group) relates to the chat start event.

Thus, in each of the communication systems which are the first through third embodiments of the invention, the users A, B, C and X (the users having called the same telephone number) sharing the same interest can be organized into a chat group as the communication server 1 selects a plurality of identifiers “A”, “B”, “C” and “X” (the respective users A, B, C and X of the plurality of user terminals 2-1, 2-2, 2-3 and 2-m) relating to the chat start event. After that, the buddy list generating/updating unit 12 can generate buddy list information of those users A, B, C and D.

In the first through third embodiments of the invention, the respective users (e.g. the users A, B, C and D) of the plurality of user terminals (e.g. the user terminals 2-1, 2-2, 2-3 and 2-4) relating to the chat start event are the users who sent transmit e-mails to the same e-mail address by using the user terminals 2-1, 2-2, 2-3 and 2-4 in a predetermined span (e.g. from 10:00 through 10:10). In this case, the user terminals 2-1, 2-2, 2-3 and 2-4 record in their respective memories the destination e-mail address, which is the same for all the terminals, and the points of time of transmission made to that destination e-mail address, and the presence information updating unit 14 of the communication server 1, by inquiring of the user terminals 2-1, 2-2, 2-3 and 2-4, registers in the presence information database 16 the destination e-mail address of transmission from the user terminals 2-1, 2-2, 2-3 and 2-4 and the points of time of their transmission as the chat group (related information), matched with the identifiers of the user terminals 2-1, 2-2, 2-3 and 2-4. Then, the group organizing unit 11 perceives the occurrence of a chat start event when, for instance, a first point of time (10:10) has come, references the presence information database 16, selects out of the identifiers “X”, “A”, “B”, “C”, “D” and “E” . . . , a plurality of identifiers “A”, “B”, “C” and “X” of which the presence information is “Online” indicating accessibility and the related information (chat group) relates to the chat start event.

Thus, in each of the communication systems which are the first through third embodiments of the invention, the users A, B, C and X (the users having transmitted to the same e-mail address) sharing the same interest can be organized into a chat group as the communication server 1 selects a plurality of identifiers “A”, “B”, “C” and “X” (the respective users A, B, C and X of the plurality of user terminals 2-1, 2-2, 2-3 and 2-m) relating to the chat start event. After that, the buddy list generating/updating unit 12 can generate buddy list information of those users A, B, C and D.

In the first through third embodiments of the invention, the respective users (e.g. the users A, B, C and D) of the plurality of user terminals (e.g. the user terminals 2-1, 2-2, 2-3 and 2-4) relating to the chat start event are the users who bought the same electronic tickets by using the user terminals 2-1, 2-2, 2-3 and 2-4 from a web site in a predetermined span (e.g. from 10:00 through 10:10). In this case, the user terminals 2-1, 2-2, 2-3 and 2-4 record in their respective memories the electronic tickets which have been bought and the points of time of having bought those electronic tickets, and the presence information updating unit 14 of the communication server 1, by inquiring of the user terminals 2-1, 2-2, 2-3 and 2-4, registers in the presence information database 16 the electronic tickets which have been bought and the points of time of having bought those electronic tickets, as the chat group (related information), matched with the identifiers of the user terminals 2-1, 2-2, 2-3 and 2-4. Then, the group organizing unit 11 perceives the occurrence of a chat start event when, for instance, a first point of time (10:10) has come, references the presence information database 16, selects out of the identifiers “X”, “A”, “B”, “C”, “D” and “E” . . . , a plurality of identifiers “A”, “B”, “C” and “X” of which the presence information is “Online” indicating accessibility and the related information (chat group) relates to the chat start event.

Thus, in each of the communication systems which are the first through third embodiments of the invention, the users A, B, C and X (the users having bought the same electronic tickets) sharing the same interest can be organized into a chat group as the communication server 1 selects a plurality of identifiers “A”, “B”, “C” and “X” (the respective users A, B, C and X of the plurality of user terminals 2-1, 2-2, 2-3 and 2-m) relating to the chat start event. After that, the buddy list generating/updating unit 12 can generate buddy list information of those users A, B, C and D.

In the first through third embodiments of the invention, the users (e.g. the users A, B, C and D) of the plurality of user terminals (e.g. the user terminals 2-1, 2-2, 2-3 and 2-4) relating to the chat start event are users present in predetermined positions (places). In this case, the group organizing unit 11 references the presence information database 16, and selects out of the identifiers “A”, “B”, “C”, “D”, “E”, . . . a plurality of identifiers “A”, “B”, “C” and “D” (selects the related users A, B, C and D) related to the presence information of “Online”, indicating accessibility, and the position (place) represented by the positional information relates to a chat start event (a predetermined position). The buddy list generating/updating unit 12 can generate buddy list information of those users A, B, C and D.

(Fourth Embodiment)

A communication system, which is a fourth preferred embodiment of the invention, is provided with a plurality of communication servers 1 in any one of the first through third embodiments.

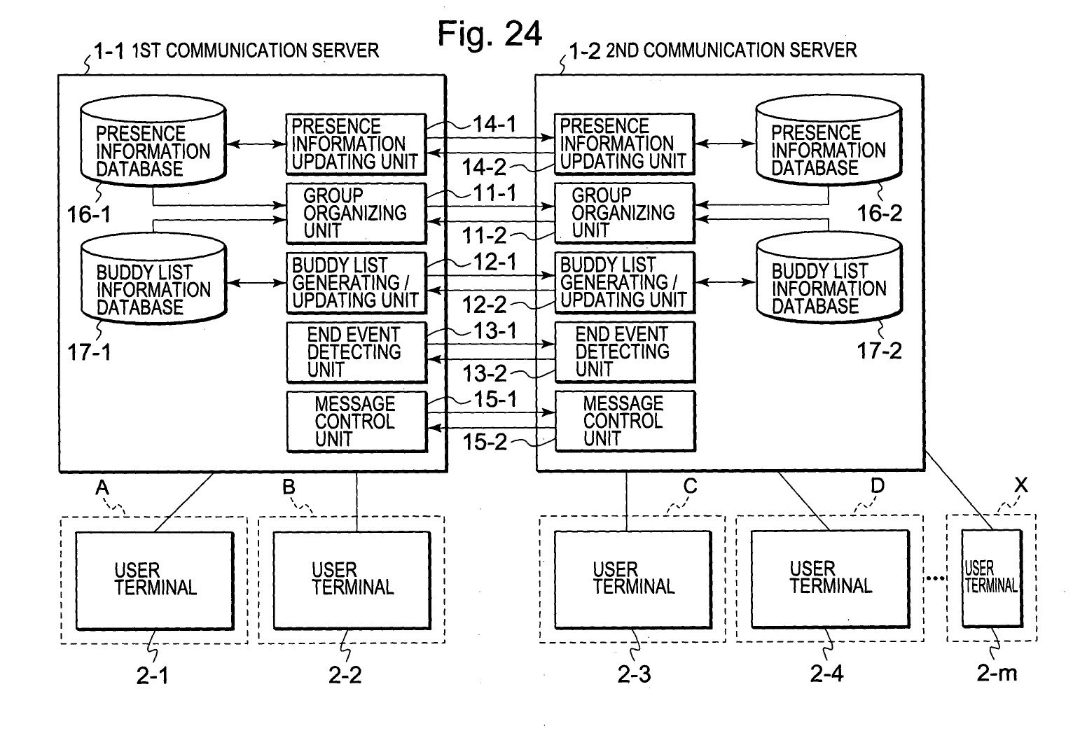

FIG. 24 is a functional block diagram illustrating the communication system, which is the fourth preferred embodiment of the invention. A plurality of communication servers 1-1 and 1-2 are mutually accessible via the communication network 4. The communication system, which is the fourth preferred embodiment of the invention, differs from the first through third embodiments in that it has a plurality of communication servers 1-1 and 1-2 each having under its management one or more of user terminals 2-1 through 2-m. Herein, as shown in FIG. 24, the first communication server 1-1 manages more than one user terminals 2-1 and 2-2, and the second communication server 1-2 manages all other user terminals 2-3 through 2-m.

Here it is supposed that the communication server 1-1 belongs to a first operator, and the communication server 1-2, to a second operator. The method of distributing the mail magazine is the same as in the first and second embodiments, and no duplication of description made of the first through third embodiments will be made.

Here, it is supposed that “A” and “B” as the identifiers (users), related information “mail magazine x” and “mail magazine x” as the chat group, “1 hour” and “1 hour” as the set chat duration, presence information “Online” and “Online” as the accessibility, and “Minato Ward” and “Shinagawa Ward” as the positional information are matched to the presence information database 16-1 of the communication server 1-1 and are registered in advance in a presence information updating unit 14-1. It is further supposed that “X”, “C”, “D”, “E”, . . . as the identifiers (users), related information “mail magazine x”, “mail magazine x”, “mail magazine x”, “mail magazine y”, . . . as the chat groups, “1 hour”, “1 hour”, “1 hour”, . . . as the set chat duration, presence information “Online”, “Offline” and “Offline” as the accessibility, and “Saitama City”, “Yokohama City”, “Kunitachi City”, “Bunkyo Ward”, . . . as the positional information are registered in advance in the presence information database 16-2 of the communication server 1-2 by a presence information updating unit 14-2.

In chat start event processing, for instance, the communication server 1-2 is to perform chat start event processing, the group organizing unit 11-2 of the communication server 1-2 references the presence information database 16-2 of the communication server 1-2 and the presence information database 16-1 of the communication server 1-1, and selects a plurality of identifiers related to the chat start event. The buddy list generating/updating unit 12-2 of the communication server 1-2 generates buddy list information by using the selected plurality of identifiers. The buddy list generating/updating unit 12-2 of the communication server 1-2 registers the newly generated buddy list information in (updates) the buddy list information database 17-2 of the communication server 1-2 and the buddy list information database 17-1 of the communication server 1-1. In this way, the communication server 1-2 communicating via the user terminals 2-3 through 2-m and the communication network 4 to manage those items of information, and can communicate with the user terminals 2-1 and 2-2 via the communication server 1-1 and the communication network 4.

For instance in message control processing, the message control unit 15 of the communication server 1-1, when a message of a broadcast formula from the user terminal 2-1 has been received, transmits the message of the broadcast formula from the user terminal 2-1 to the communication server 1-2. The message control unit 15-1 of the communication server 1-1 references buddy list information registered in the buddy list information database 17-1 of the communication server 1-1, and transmits that message to the user terminal 2-2 of another user B. The message control unit 15-2 of the communication server 1-2in response to a message of a broadcast formula from the communication server 1-1, references buddy list information registered in the buddy list information database 17-2 of the communication server 1-2, and transmits that message to the respective user terminals 2-3 and 2-4 of other users C and D (or the respective user terminals 2-3 and 2-m of other users C and X).

As described so far, the communication system, which is the fourth embodiment of the invention, provides the same advantage as the first through third embodiments do.

The foregoing description reveals that the communication system according to the invention enables, when a chat start event has arisen, users relating to the chat start event to participate in chatting at the same time by having a communication server transmit chart start information to a plurality of user terminals.

The communication system according to the invention can also organize users sharing the same interest into a chat group by having a communication server select a plurality of identifier relating to the chat start event.

Further the communication system according to the invention can enable each user to identify other users participating in a chart by displaying buddy list information on each user terminal.

While this invention has been described with reference to certain preferred embodiments thereof, it is to be understood that the subject matter encompassed by this invention is not to be limited to those specific embodiments. Instead, it is intended for the subject matter of the invention to include all such alternatives, modifications and equivalents as can be included within the spirit and scope of the following claims.

What is claimed is:

1. A communication system comprising:
a plurality of user terminals connected to a communication network, and
a communication server connected to said communication network, wherein:
said communication server, when a chat start event has occurred, causes a chat to be started at a prescribed timing among those user terminals, out of said plurality of user terminals, related in advance to said chat start event.

2. The communication system, as claimed in claim 1, wherein:
said communication server, when a chat end event has occurred, causes said chat to end at a prescribed timing among said plurality of user terminal.

3. The communication system, as claimed in claim 2, wherein:
said communication server is further provided with a buddy list generating/updating unit, wherein:
said buddy list generating/updating unit, when said chat start event has occurred, generates a buddy list information which relates the users of said plurality of user terminals to one another as buddies, transmits it to said plurality of user terminal at a prescribed timing and, when said chat end event has occurred, said buddy list generating/updating unit transmits to said plurality of user terminals at a prescribed timing buddy list delete information for deleting said buddy list information transmitted to said plurality of user terminals.

4. The communication system, as claimed in claim 3, wherein:
each of said user terminals is provided with a filtering unit for referencing said buddy list information for users available for said chat and selecting users available for chatting out of the users represented by said buddy list information.

5. The communication system, as claimed in claim 1, wherein:
said communication server registers, out of the users of said plurality of user terminals, users each having made a call to a prescribed telephone number within a predetermined span of time as the users of user terminals related to said chat start event.

6. The communication system, as claimed in claim 1, wherein:
said communication server registers, out of the users of said plurality of user terminals, users each having transmitted an e-mail to a prescribed e-mail address within a predetermined span of time by using their respective user terminals as the users of user terminals related to said chat start event.

7. The communication system, as claimed in claim 1, wherein:
said communication server registers, out of the users of said plurality of user terminals, users having bought electronic tickets within a predetermined span of time from a prescribed web site by using their respective user terminals as the users of user terminals related to said chat start event.

8. The communication system, as claimed in claim 1, wherein:
said communication server registers users present in predetermined positions as the users of user terminals related to said chat start event.

9. The communication system, as claimed in claim 1, wherein:
said communication server is provided with a group organizing unit for receiving an e-mail distributed to said plurality of user terminal, and
said group organizing unit, upon receiving said e-mail, perceives the occurrence of said chat start event.

10. The communication system, as claimed in claim 1, wherein:
said communication server is provided with a group organizing unit which, when an e-mail is received from the user terminal of a specific user out of said plurality of user terminals, perceives the occurrence of said chat start event.

11. The communication system, as claimed in claim 2, wherein:
said communication server is provided with an end event detecting unit which detects the ending time after the lapse of a set length of time from the point of time when said chat start event occurred, and
said end event detecting unit, when it detects said ending time, perceives said chat end event.

12. The communication system, as claimed in claim 1, wherein:
said communication server is provided with a presence information database in which is registered presence information indicating whether or not the users of said user terminals are accessible, and
a group organizing unit which references said presence information database and perceives the occurrence of said chat start event when said presence information of a specific user out of the respective users of said plurality of user terminals indicates accessibility.

13. The communication system, as claimed in claim 2, wherein:
said communication server is provided with a presence information database in which is registered presence information indicating whether or not the users of said user terminals are accessible, and
a group organizing unit which references said presence information database and perceives the occurrence of said chat end event when said presence information of a specific user out of the respective users of said plurality of user terminals indicates inaccessibility.

14. The communication system, as claimed in claim 1, wherein:
said communication server is provided with a group organizing unit which perceives the occurrence of said chat start event when a predetermined first point of time has come.

15. The communication system, as claimed in claim 2, wherein:
said communication server is provided with an end event detecting unit which perceives the occurrence of said chat end event when a predetermined second point of time has come.

16. The communication system, as claimed in claim 2, wherein:
said communication server is provided with an end event detecting unit which perceives the occurrence of said chat end event if, after the lapse of a set length of time since messages were transmitted/received among said plurality of user terminals, no transmission/reception of messages takes place again among said plurality of user terminals.

17. A communication server connected to a plurality of user terminals via a communication network, comprising:
a presence information database in which are registered an identifier by which each of said plurality of user terminals identifies itself and related information,
a group organizing unit which, when a chat start event has occurred, references said presence information database and selects, out of the identifiers of said plurality of user terminals, identifier of which said related information relates to said chat start event, and
a buddy list generating/updating unit which transmits chart start information to user terminals matched to identifiers relating to said start event out of said plurality of user terminals, wherein:
said chart start information is an item of information to cause a chat to start at a prescribed timing among said plurality of user terminals.

18. The communication server, as claimed in claim 17, further provided with:
a buddy list information database, wherein:
said buddy list generating/updating unit generates buddy list information to relate as buddies to one another the users of said plurality of user terminals matching said plurality of identifiers selected by said group organizing unit, registers it in said buddy list information database, and transmits said buddy list information, together with said chart start information, to said plurality of user terminals.

19. The communication server, as claimed in claim 18, further provided with:
an end event detecting unit which perceives chat end event, wherein:
said buddy list generating/updating unit, when said chat end event has occurred, transmits chat end information to said plurality of user terminals, and
said chat end information is an item of information to end said chat at a prescribed timing among said plurality of user terminals.

20. The communication server, as claimed in claim 19, wherein:
said end event detecting unit, when it has perceived said chat end event, deletes said buddy list information registered in said buddy list information database, and generates buddy list delete information to delete said buddy list information transmitted to said plurality of user terminals, and
said buddy list generating/updating unit transmits said buddy list delete information, together with said chat end information, to said plurality of user terminals.

21. The communication server, as claimed in claim 17, wherein:
users having called a prescribed telephone number within a predetermined span of time by using their respective user terminals, out of said plurality of user terminals, are further registered as the users of user terminals related to said chat start event.

22. The communication server, as claimed in claim 17, wherein:
users having transmitted e-mails to a prescribed e-mail address within a predetermined span of time by using their respective user terminals, out of said plurality of user terminals, are further registered as the users of said user terminals related to said chat start event.

23. The communication server, as claimed in claim 17, wherein:
users having bought electronic tickets within a predetermined span of time from a prescribed web site by using their respective user terminals, out of the users of said plurality of user terminals, are further registered as the users of user terminals related to said chat start event.

24. The communication server, as claimed in claim 17, wherein:
users present in predetermined positions are further registered as the users of user terminals related to said chat start event,
positional information, matched to said identifiers, are further registered in said presence information database,
said positional information represents the positions of said user terminals, and
said group organizing unit references said presence information database and selects, out of said identifier, said plurality of identifiers whose positions indicated by said positional information relate to said chat start event.

25. The communication server, as claimed in claim 19, wherein:
set chat durations, matched to said identifiers, are further registered in said presence information database,
said buddy list information includes the ending time, and said ending time represents the point of time at which said chat duration has passed since the starting time of said chat,
said end event detecting unit references said buddy list information database and, if said ending time has come, perceives the occurrence of said chat end event, and
said buddy list generating/updating unit transmits said chat end information at said ending time to said plurality of user terminals.

26. The communication server, as claimed in claim 17, wherein:
presence information, matched to said identifiers, is further registered in said presence information database,
said presence information indicates whether or not each of the users of said user terminals is accessible, and
said group organizing unit, when said chat start event has occurred, references said presence information database and selects, out of said identifiers, a plurality of identifiers of which said presence information indicates accessibility and said related information relates to said chat start event.

27. The communication server, as claimed in claim 17, wherein:
said group organizing unit, when it has received the same e-mail as the e-mail distributed to said plurality of user terminals, perceives the occurrence of said chat start event.

28. The communication server, as claimed in claim 17, wherein:
said group organizing unit, when it has received an e-mail from the terminal of a prescribed user, out of the users of said plurality of user terminals, perceives the occurrence of said chat start event.

29. The communication server, as claimed in claim 17, wherein:
said presence information database matches said identifiers to said related information and presence information, and said presence information indicates whether or not each of the users of said user terminals is accessible, and
said group organizing unit references said presence information database and, when said presence information of a specific user out of the users of said plurality of user terminals indicates accessibility, perceives the occurrence of said chat start event.

30. The communication server, as claimed in claim 19, wherein:
said presence information database matches said identifiers to said related information and presence information, and said presence information indicates whether or not each of the users of said user terminals is accessible, and
said end event detecting unit references said presence information database and, when said presence information of a specific user out of the users of said plurality of user terminals indicates inaccessibility, perceives the occurrence of said chat end event.

31. The communication server, as claimed in claim 17, wherein:
said group organizing unit perceives the occurrence of said chat start event when a predetermined first point of time has come.

32. The communication server, as claimed in claim 19, wherein:
said end event detecting unit perceives the occurrence of said chat end event when a predetermined second point of time has come.

33. The communication server, as claimed in claim 19, wherein:
said end event detecting unit perceives the occurrence of said chat end event if, after the lapse of a set length of time since messages were transmitted/received among said plurality of user terminals, no transmission/reception of messages takes place again among said plurality of user terminals.

34. The communication system provided with a plurality of communication servers claimed in claim 17, comprising:
said plurality of communication servers are mutually accessible via said communication network, and
one of said plurality of communication servers communicates with at least one user terminal out of said user terminals via said communication network, and communicates with other user terminals than said at least one user terminal out of said user terminals via said communication network by communicating with other communication servers than said one communication server out of said plurality of communication servers via said communication network.

35. A communication method using a communication server connected to a plurality of user terminals via a communication network, comprising the steps of:
(a) starting a chat at a prescribed timing, when a chat start event has occurred, among a plurality of user terminals, out of said user terminals, related in advance to said chat start event, and
(b) ending said chat at a prescribed timing, when a chat end event has occurred, among said plurality of user terminals.

36. The communication method, as claimed in claim 35, wherein:
said (a) further includes generation, when said chat start event has occurred, of buddy list information to mutually relate as buddies the users of said plurality of user terminals, and its transmission at a prescribed timing to said plurality of user terminals, said buddy list information indicating users available for participation in said chat.

37. The communication method, as claimed in claim 35, wherein:
said (b) further includes transmission at a prescribed timing, when said chat end event has occurred, of buddy list delete information to said plurality of user terminals to delete said buddy list information transmitted to said plurality of user terminals.

38. A computer program for causing communication among user terminals to be executed by using a communication server connected to a plurality of user terminals via a communication network, comprising the steps of:
(a) starting a chat at a prescribed timing, when a chat start event has occurred, among a plurality of user terminals, out of said user terminals, related in advance to said chat start event, and
(b) ending said chat at a prescribed timing, when a chat end event has occurred, among said plurality of user terminals.

39. The computer program, as claimed in claim 38, wherein:
said (a) further includes generation, when said chat start event has occurred, of buddy list information to mutually relate as buddies the users of said plurality of user terminals, and its transmission at a prescribed timing to said plurality of user terminals, said buddy list information indicating users available for participation in said chat.

40. The computer program, as claimed in claim 38, wherein:
said (b) further includes transmission at a prescribed timing, when said chat end event has occurred, of buddy list delete information to said plurality of user terminals to delete said buddy list information transmitted to said plurality of user terminals.
